(19) United States
(12) Patent Application Publication
(10) Pub. No.: US 2025/0198957 A1
(43) Pub. Date: Jun. 19, 2025

(54) THERMAL CONDUCTIVITY MEASUREMENT DEVICES, SYSTEMS, AND METHODS

(71) Applicants: Mohammad Amin KAZEMI, Toronto (CA); Mohammad ZARGARTALEBI, Toronto (CA); David SINTON, Toronto (CA)

(72) Inventors: Mohammad Amin KAZEMI, Toronto (CA); Mohammad ZARGARTALEBI, Toronto (CA); David SINTON, Toronto (CA)

(21) Appl. No.: 18/979,002

(22) Filed: Dec. 12, 2024

Related U.S. Application Data
(60) Provisional application No. 63/611,481, filed on Dec. 18, 2023.

(51) Int. Cl. G01N 25/18; H05B 3/00

(52) U.S. Cl. CPC G01N 25/18; H05B 3/0014; H05B 2203/007

(57) ABSTRACT

A device for measuring thermal conductivity includes (a) a heater system including a plurality of resistive heaters and a voltage measurement system for measuring voltage across each resistive heater; (b) at least one thermal reservoir maintainable at a reservoir temperature; and (c) a set of chambers positioned between the heater system and the thermal reservoir. Each chamber is fillable with fluid to a respective chamber height extending between an inner end in thermal communication with a respective heater and an outer end in thermal communication with the thermal reservoir. The set of chambers includes at least one sample chamber for filling with a sample medium and a plurality of reference chambers for containing a reference medium and having different chamber heights from each other for providing a different thermal resistance through each chamber height of reference medium.

### CROSS-REFERENCE TO RELATED APPLICATION(S)

This application claims the benefit of U.S. Provisional Patent Application No. 63/611,481 filed Dec. 18, 2023, which is hereby incorporated herein by reference in its entirety.

### FIELD

The present disclosure relates to measurement of thermal conductivity.

### INTRODUCTION

The accurate measurement of thermal conductivity in fluids is essential for a wide range of industries, including engineering, materials science, and environmental studies. Thermal conductivity is a fundamental property that describes a material's ability to conduct heat, and can be of utmost importance in designing efficient heat transfer systems and understanding thermal behavior in various applications. The growing demand for faster and more efficient thermal conductivity measurement techniques has become evident, particularly with the increasing interest in nanomaterials and nanofluids, which often necessitate working with small sample volumes. Over the years, significant progress has been made in developing devices and approaches to measure thermal conductivity. However, prevailing techniques encounter constraints that impede their efficiency and broad applicability.

Thermal conductivity measurement methods for fluids can be categorized as steady-state and transient methods. Steady-state methods, such as guarded hot plate and heat flow meter methods, offer accurate results but are time-consuming, especially for low thermal conductivity materials such as fluids. Due to the relatively long time required for measurements, steady-state methods face challenges with materials prone to evaporation, degradation, or instability at elevated temperatures, limiting the number of measurements and timeframes.

Transient methods, such as transient hot-wire and transient plane source methods, provide faster measurements by subjecting the sample to a sudden heat pulse and measuring the subsequent temperature change. However, they suffer from inaccuracies due to heat losses to the surrounding environment, compromising precision, especially for samples with low thermal conductivity. Transient methods also encounter difficulties with small sample volumes, reducing measurement precision as the signal-to-noise ratio decreases. Therefore, they require a relatively large sample volume to prevent heat from crossing the liquid boundary during measurement, complicating accurate assessments of thermal conductivity in fluids.

### SUMMARY

The following summary is intended to introduce the reader to various aspects of the applicant's teaching, but not to define any invention.

According to some aspects, a method for measuring thermal conductivity of a sample medium having an unknown thermal conductivity includes: (a) filling a sample chamber of a set of chambers with the sample medium, the set of chambers further including a plurality of reference chambers filled with a reference medium having a known thermal conductivity. Each chamber of the set of chambers has a chamber height of respective medium when filled. The chamber height extends from an inner end of the chamber to an outer end of the chamber opposite the inner end, and each reference chamber has a different chamber height of reference medium from each other reference chamber to provide a different thermal resistance through each chamber height of reference medium. The method further includes (b) supplying heat energy to the inner end of each chamber while maintaining the outer end of each chamber at a common fixed temperature for conduction of heat through each chamber height of sample and reference media from the inner end to the outer end. The heat energy is supplied by applying current through a plurality of resistive heaters, each resistive heater in thermal communication with the inner end of a respective chamber of the set of chambers. The method further includes (c), during (b), measuring voltage across each resistive heater during steady state conditions to define a plurality of voltage values; and (d) determining the unknown thermal conductivity based on the known thermal conductivity of the reference medium and a relationship between the plurality of voltage values relative to respective chamber heights of the sample and reference media.

In some examples, (d) includes: (i) determining a functional relationship between the voltage values defined in (c) for the plurality of reference chambers and the chamber heights of reference medium in the plurality of reference chambers; (ii) determining, based on the functional relationship, an estimated chamber height of reference medium corresponding to the voltage value defined in (c) for the chamber height of sample medium in the sample chamber; and (iii) determining the unknown thermal conductivity based on the known thermal conductivity and a ratio of the chamber height of sample medium relative to the estimated chamber height of reference medium.

In some examples, the functional relationship is linear.

In some examples, the plurality of resistive heaters are connected in series and have a generally identical resistance to each other for generating equal heat output under identical conditions.

In some examples, each voltage value defines the inverse of the voltage measured in (c) for a respective heater.

In some examples, the outer end of each chamber is in thermal communication with a thermal reservoir held at a reservoir temperature for maintaining the outer end of each chamber at the constant temperature during (b).

In some examples, each thermal reservoir comprises a thermal block in thermal communication with the outer end of each chamber, and (c) includes operating a thermoelectric module coupled to the block to maintain the block at the reservoir temperature.

In some examples, the plurality of chambers are formed in an insulating layer positioned between the heater system and the thermal reservoir.

In some examples, the set of chambers in (a) define a first set of the chambers, and the method further includes providing a second set of chambers identical to the first set of chambers and arranged symmetrically on an opposite side of the plurality of heaters to define a plurality of symmetrical pairs of chambers, the chambers in each pair having a same chamber height, containing a same medium, and in alignment with each other on opposite sides of a respective heater for receiving heat energy from the respective heater through the inner end of the chambers while the outer end of the chambers is maintained at the fixed temperature.

In some examples, the sample medium comprises a fluid and the filling step (a) comprises pumping the sample medium into the sample chamber.

In some examples, the reference medium comprises one of a fluid and a solid.

According to some aspects, a device for measuring thermal conductivity of sample media includes: (a) a heater system including a plurality of resistive heaters operable to generate heat energy and a voltage measurement system configured to measure voltage across each resistive heater to define a plurality of voltage values; (b) at least one thermal reservoir maintainable at a fixed reservoir temperature; and (c) at least one set of chambers, each set of chambers positioned between the heater system and a respective thermal reservoir, each chamber having a respective chamber height between an inner end of the chamber and an outer end of the chamber opposite the inner end, the inner end of each chamber in thermal communication with a respective resistive heater of the heater system for receiving heat energy from the respective heater, and the outer end of each chamber in thermal communication with the respective thermal reservoir for maintaining the outer end of each chamber at a common temperature corresponding to the reservoir temperature. Each set of chambers includes at least one sample chamber for filling with a sample medium having an unknown thermal conductivity and a plurality of reference chambers for containing a reference medium having a known thermal conductivity. The plurality of reference chambers of each set of chambers have different chamber heights from each other for providing a different thermal resistance through each chamber height of reference medium, and for determining the unknown thermal conductivity based on the known thermal conductivity of the reference medium and a relationship between the plurality of voltage values relative to respective chamber heights of the sample and reference medium.

In some examples, the plurality of resistive heaters are connected in series to each other. In some examples, the resistive heaters have a generally identical resistance to each other for generating equal heat output under identical conditions.

In some examples, each thermal reservoir comprises a thermal block in thermal communication with the outer end of a respective set of chambers and a thermoelectric module coupled to the block and operable to maintain the block at the reservoir temperature.

In some examples, each set of chambers is formed in an intermediate layer of material positioned between the heater system and the respective thermal reservoir.

In some examples, the sample chamber comprises a microchannel formed in the intermediate layer and configured for flow-through of sample medium through the sample chamber to facilitate filling and evacuation of the sample chamber.

In some examples, the reference chambers comprise microchannels formed in the intermediate layer and configured for flow-through of the reference medium through the references chambers to facilitate filling and evacuation of the reference chambers.

In some examples, the material of the intermediate layer has a relatively low thermal conductivity to thermally isolate the set of chambers from each other in a lateral direction perpendicular to the chamber height for facilitating one-dimensional heat transfer along the chamber height.

In some examples, the outer end of the chambers in each set is closed by the respective thermal reservoir.

In some examples, the inner end of each chamber is electrically insulated from the respective heater by an insulating substrate positioned between the inner end and the respective heater.

In some examples, the device further includes a pump system including at least one sample pump in fluid communication with each sample chamber for pumping the sample medium thereto.

In some examples, the pump system further includes at least one reference pump in fluid communication with the plurality of reference chambers for pumping the reference medium thereto.

In some examples, the reference chambers are prefilled with the reference medium.

In some examples, the reference medium comprises a solid.

In some examples, the at least one thermal reservoir includes a pair of thermal reservoirs on opposite sides of the heater system, and the at least one set of chambers includes a pair of sets of the chambers arranged symmetrically on opposite sides of the heater system between the heater system and respective thermal reservoirs. In some examples, the pair of sets of chambers define a plurality of symmetrical pairs of the chambers, the chambers in each pair having a same chamber height, filled with a same medium, and in alignment with each other on opposite sides of a respective heater for receiving heat energy from the respective heater through the inner end of the chambers while the outer end of the chambers is maintained at the common temperature.

In some examples, the device further includes a control system configured to: (i) energize the thermal reservoir to maintain the outer end of the chambers at a common, fixed temperature; and (ii) energize the plurality of heaters to supply heat energy to the inner end of respective chambers for conduction through each chamber height of medium to the thermal reservoir.

In some examples, the device further includes at least one processor configured to determine the unknown thermal conductivity based on the known thermal conductivity of the reference medium and a relationship between the plurality of voltage values relative to respective chamber heights of the sample and reference medium.

According to some aspects, a method for measuring thermal conductivity of a sample medium having an unknown thermal conductivity includes: (a) filling a sample chamber of a set of chambers with the sample medium, the set of chambers further including a plurality of reference chambers filled with a reference medium having a known thermal conductivity. Each chamber of the set of chambers has a chamber height of respective medium when filled. The chamber height extends from an inner end of the chamber to an outer end of the chamber opposite the inner end, and each reference chamber has a different chamber height of reference medium from each other reference chamber to provide a different thermal resistance through each chamber height of reference medium. The method further includes (b) supplying heat energy to the inner end of each chamber while maintaining the outer end of each chamber at a common fixed temperature for conduction of heat through each chamber height of sample and reference media from the inner end to the outer end; and (c), during (b), measuring a parameter for each heater during steady state conditions to define a plurality of parameter values, each parameter value corresponding to a temperature differential between the inner end and the outer end of a respective chamber; and (d) determining the unknown thermal conductivity based on the known thermal conductivity of the reference medium and a relationship between the plurality of parameter values relative to respective chamber heights of the sample and reference media.

In some examples, each heater comprises a resistive heater, and each parameter measured in (c) comprises voltage measured across a respective resistive heater.

According to some aspects, a device for measuring thermal conductivity of a sample medium includes: (a) a heater system including a plurality of heaters; (b) a thermal reservoir; (c) a set of chambers between the heater system and the thermal reservoir, each chamber fillable with medium to a respective chamber height extending between an inner end in thermal communication with a respective heater and an outer end in thermal communication with the thermal reservoir, the set of chambers including a sample chamber for filling with the sample medium and a plurality of reference chambers for filling with a reference medium, the plurality of reference chambers having different chamber heights from each other; and (d) a parameter measurement system configured to measure a parameter for each heater to define a plurality of parameter values, each parameter value corresponding to a temperature differential between a respective heater and the thermal reservoir for determining an unknown thermal conductivity of the sample medium based on a known thermal conductivity of the reference medium and a relationship between the plurality of parameter values relative to respective chamber heights of the sample and reference medium in the set of chambers.

In some examples, each heater comprises a resistive heater, and the parameter measurement system comprises a voltage measurement system configured to measure voltage across each resistive heater to define a plurality of voltage values for determining the unknown thermal conductivity.

### BRIEF DESCRIPTION OF THE DRAWINGS

The drawings included herewith are for illustrating various examples of devices, systems, and methods of the present specification and are not intended to limit the scope of what is taught in any way. In the drawings:

FIG. 1A is a schematic side view of an example device for measuring thermal conductivity, showing all chambers of the device filled with a reference medium;

FIG. 1B is a graph showing a plurality of inverse voltages for heaters of the device relative to different chamber heights of the reference medium;

FIG. 1C is an enlarged view of a portion of the device of FIG. 1A;

FIG. 2A is a schematic side view of the device of FIG. 1A, but with one chamber filled with a sample medium and the remaining chambers filled with the reference medium;

FIG. 2B is a graph showing inverse voltages for the heaters relative to the chamber heights of sample and reference media;

FIG. 3 is a schematic side view of an example thermal conductivity measurement system including the device of FIG. 2A;

FIG. 4 is an enlarged view of a portion of the system of FIG. 3;

FIG. 5 is a partially exploded perspective view of heater and reservoir portions of the system of FIG. 3;

FIG. 6 is a close-up view of heaters and respective chambers of the system of FIG. 3, with an insulating substrate not depicted for clarity;

FIG. 7 is a flowchart showing an example method for determining thermal conductivity of a sample medium using a system like that of FIG. 3;

FIG. 8 is a graph showing thermal conductivities determined for eleven sample fluids using a system like that of FIG. 3, relative to accepted literature values;

FIG. 9A is a graph showing thermal conductivities determined for fluids using a system like that of FIG. 3 as a function of a component concentration of the fluids;

FIG. 9B is a graph showing thermal conductivities determined for another sample fluid using a system like that of FIG. 3 as a function of a component concentration of the fluid;

FIG. 9C is a graph showing thermal conductivities determined for another fluid using a system like that of FIG. 3 as a function of a component concentration of the fluid;

FIG. 9D is a graph showing thermal conductivities determined for a nanofluid using a system like that of FIG. 3 as a function of a component concentration of the nanofluid;

FIG. 10A is a graph showing thermal conductivities determined for a fluid at various temperatures using a system like that of FIG. 3, relative to accepted literature values;

FIG. 10B is a graph showing thermal conductivities determined for another fluid at various temperatures using a system like that of FIG. 3, relative to accepted literature values;

FIG. 10C is a graph showing thermal conductivities determined for another sample fluid at various temperatures using a system like that of FIG. 3, relative to accepted literature values;

FIG. 11A is a graph showing voltage response over time of a chamber height of sample fluid and a plurality of different chamber heights of reference fluid during measurement of thermal conductivity using a system like that of FIG. 3; and

FIG. 11B is a graph showing the steady state voltage values for the chamber heights of the sample and reference fluids of FIG. 11A.

### DETAILED DESCRIPTION

Various devices, systems, or methods will be described below to provide an example of an embodiment of each claimed invention. No embodiment described below limits any claimed invention and any claimed invention may cover devices, systems, or methods that differ from those described below. The claimed inventions are not limited to devices, systems, or methods having all of the features of any one device, system, or method described below or to features common to multiple or all of the devices, systems, or methods described below. It is possible that a device, system, or method described below is not an embodiment of any claimed invention. Any invention disclosed in a device, system, or method described herein that is not claimed in this document may be the subject matter of another protective instrument, for example, a continuing patent application, and the applicants, inventors, or owners do not intend to abandon, disclaim, or dedicate to the public any such invention by its disclosure in this document.

According to some aspects, the present disclosure is directed to thermal conductivity measurement devices, systems, and methods that may address certain shortcomings in existing designs. According to some aspects, the devices of the present disclosure can be in the form of flow-through microfluidic devices that combine certain advantages of steady-state and transient methods for thermal conductivity measurement. In some examples, measurement can be relatively fast (e.g. <10 s per measurement), accurate (e.g. ±1%), and/or require a relatively small volume of fluid (e.g. 10 μL/measurement). In some examples, the accuracy can be comparable to some industry leading commercial devices, enabling precise measurements of thermal conductivity in liquids, gases, and/or mixtures. In some examples, the non-contact approach and enclosed chamber of the devices of the present disclosure can also make them suitable for volatile liquids and gases. Furthermore, in some examples, the devices utilize a symmetric configuration of sample and reference chambers, which can help amplify sensitivity, improve reliability, and allow for replication of measurements in shorter timeframes. Furthermore, in some examples, the device is configured for flow-through of the fluids, which can allow for relatively fast, continuous, and/or autonomous measurement, which can accelerate material screening and discovery processes in certain industries.

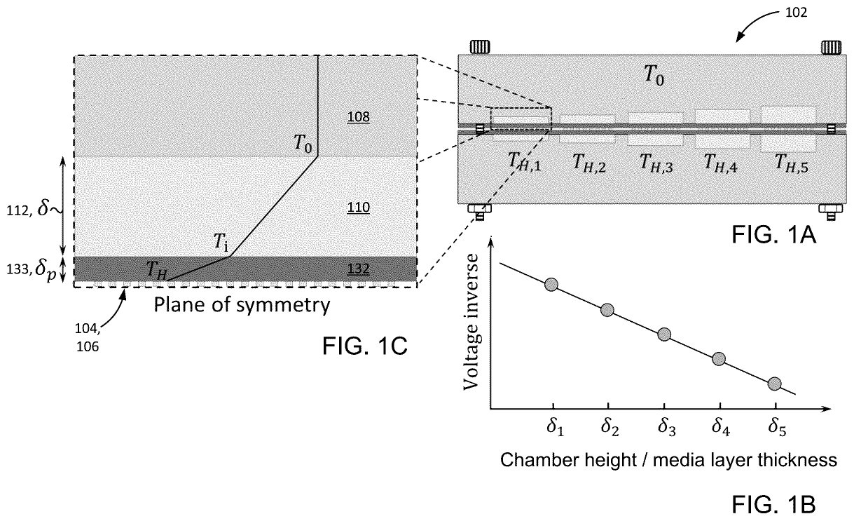

Referring to FIGS. 1A-1C, the measurement of thermal conductivity of the present disclosure is, in some examples, based on monitoring voltage in a plurality of heaters at respective temperatures (T_{H,1}-T_{H,5}) and in thermal communication with respective media layers having respective thicknesses (δ₁-δ₅). The term “medium” and “media” as used herein refers to a gas, liquid, or solid through which heat can be conducted to facilitate measurement of thermal conductivity according to the present teachings. In some examples, each heater is positioned between two respective media layers of equal thickness. In some examples, the heaters are resistive heaters, and when an electric current is applied to the heaters, the heaters experience a temperature increase due to Joule heating. The temperature of the heaters reaches a steady state value which is determined by the thermal resistance of respective media layers. Heaters covered by media layers that are relatively thicker and/or have a lower coefficient of thermal conductivity (k) struggle to effectively dissipate the generated heat. As a result, those heaters will reach a higher steady state temperature relative to heaters covered by fluid layers that are relatively thinner and/or have a higher k.

In examples in which media layers are provided on both sides of the heaters, the power generated by a heater (P=VI) at steady-state conditions is twice the heat conducted through the respective medium layer and the insulating (e.g., polyimide) substrate that is located between the heaters and the media layers, as the system is symmetric:

$$VI = 2 \frac{{T}_{H} - {T}_{0}}{( \frac{δ}{k} + \frac{{δ}_{p}}{{k}_{p}} )}$$

where V is voltage, I is current, T_{H} is the temperature of the heaters, T₀ is the temperature of a thermal reservoir (e.g., copper block) on an opposite side of the media layers, δ and k are the thickness and thermal conductivity of the medium layer, respectively, and δₚ and kₚ are the thickness and thermal conductivity of the insulating substrate, respectively.

Using the Ohm's law (V=RI) and assuming a linear dependence of the heater temperatures to the temperature offset (T_{H}-T₀), the voltage may be related to the temperature offset by:

$$V = RI = {R}_{0} I ( 1 + α ( {T}_{H} - {T}_{0} ) )$$

where R₀ is the resistance at T₀ and α is the temperature coefficient of resistance. Therefore, in some examples, the relation between the voltage and the substance thickness is found to be linear as:

$$\frac{1}{V} = - ( \frac{α I}{2 k} ) δ + ( \frac{1}{{R}_{0} I} - \frac{α I {δ}_{p}}{2 {k}_{p}} )$$

Referring to FIGS. 1A and 1B, when a plurality of chambers of different heights (δ₁-δ₅) are filled with media of the same k, the inverse voltage forms a linear relationship with the thickness of medium in each chamber (corresponding to the chamber height). In such examples, the slope is constant due to the same current passing through all resistive heaters. The unknown thermal conductivity of a sample medium may be determined relative to the known thermal conductivity of a reference medium.

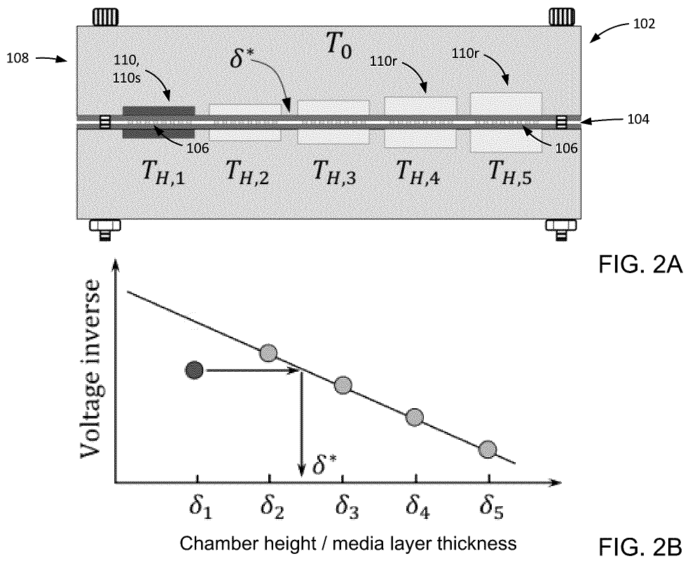

Referring to FIGS. 2A and 2B, for this purpose, one of the chambers (e.g. corresponding to chamber height/medium thickness 81) is filled with a sample medium of unknown k while others (e.g. corresponding to chamber heights/medium thicknesses δ₂₋₅) contain the reference medium of known k_{ref}. By applying a current through the heaters, the voltage value for the sample medium heater (heater 1, in the example illustrated) deviates from the situation where that same chamber were to be filled with the reference medium, as shown in FIG. 2B. To determine the thermal conductivity of the sample medium, one can find the corresponding thickness (chamber height) of the reference medium (denoted as δ*) that would result in the same thermal resistance (i.e. have the same inverse voltage value) as the sample medium. Once δ* is found, the thermal conductivity k of the sample medium can be calculated by, for example:

$$k = ( \frac{{δ}_{1}}{{δ}^{*}} ) {k}_{ref}$$

This relative measurement approach can offer certain advantages over some conventional methods. For example, it can help improve measurement accuracy by, for example, reducing impact of thermal disturbances from surrounding environment, reducing uncertainties associated with temperature sensors, and/or unwanted effects of insulating substrate positioned between the heaters and the media layers. Unlike single-fluid measurement approaches, the methods of the present disclosure can also provide a more dependable and/or robust assessment of thermal conductivity. Furthermore, the differential measurement approach can help streamline the process by replacing the need for internal heater temperature readings with voltage measurements and does not necessarily require quantification of the current (I) or temperature differentials (T_{H,i}-T₀). This can allow for enhanced miniaturization of the setup and sample volume without necessarily compromising accuracy relative to some existing designs. This can help sidestep the complexities of temperature sensing—for example, avoiding contact with sample fluid to prevent short circuits while still being able to sense the temperature of the fluid and deal with uncertainties in sensor placement for small-volume fluids. The present teachings can also counter challenges associated with current measurement during resistive heating, often faced with multimeters, and help reduce potential inaccuracies from thermal disturbances, such as temperature fluctuations, that single fluid channel measurements may be prone to.

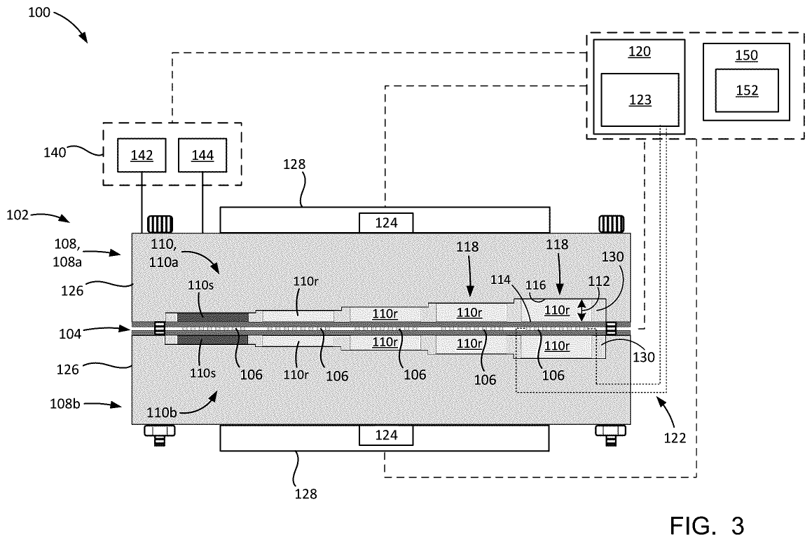

Referring to FIG. 3, an example thermal conductivity measurement system 100 for measuring thermal conductivity of fluids is shown schematically. The system 100 includes a thermal conductivity measurement device 102. The device 102 includes a heater system 104 having a plurality of heaters 106 operable to generate heat energy, at least one thermal reservoir 108 maintainable at a fixed reservoir temperature, and a respective set of chambers 110 for filling with media between the heater system 104 and each thermal reservoir 108.

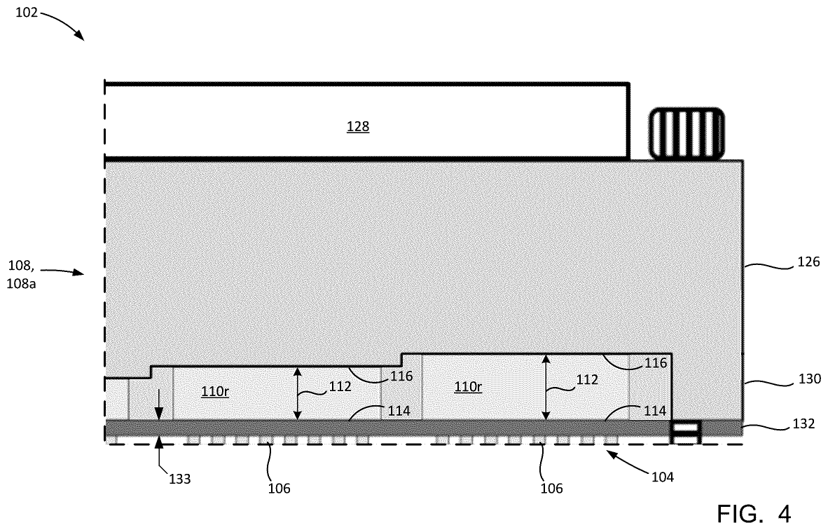

Referring to FIG. 4, in the example illustrated, each chamber 110 has a respective chamber height 112 between an inner end 114 of the chamber 110 and an outer end 116 of the chamber opposite the inner end 114. Each chamber height 112 corresponds to the thickness of medium in the chamber when filled. In the example illustrated, the inner end 114 of each chamber 110 is in thermal communication with a respective heater 106 of the heater system 104 for receiving heat energy from the respective heater 106. The outer end 116 of each chamber 110 is in thermal communication with the thermal reservoir 108 for maintaining the outer end 116 of each chamber 110 at a common temperature corresponding to the reservoir temperature.

Referring to FIG. 3, in the example illustrated, each set of chambers 110 includes at least one sample chamber 110s for filling with a sample medium having an unknown thermal conductivity. In the example illustrated, the sample medium comprises a sample fluid. Each set of chambers 110 further includes a plurality of reference chambers 110r for filling with a reference medium having a known thermal conductivity. In the example illustrated, the reference medium comprises a reference fluid.

In other examples, the reference medium can comprise a reference solid. In such examples, the reference chambers 110r can be prefilled with the reference solid, for example, during fabrication of the device 102. The reference solid can have a thermal conductivity that is less than the thermal conductivity of the thermal block material (described below) of the thermal reservoir 108. Examples of suitable reference solids include, but are not limited to, glass ceramics (k=3.84 W/m·K), Pyrex® glass (k=1.1438 W/m·K), Perspex® (k=0.1904 W/m·K), resin-bonded glass fibre board (k=0.0316 W/m·K), etc., each of which have a thermal conductivity that is significantly less (e.g. at least 100 times less) than that of the thermal block material (e.g. copper (k=401 W/m·K)).

In the example illustrated, each set of chambers 110 is shown to include one sample chamber 110s and a plurality of the reference chambers 110r (four reference chambers 110r, in the example illustrated). Referring to FIG. 4, in the example illustrated, the plurality of reference chambers 110r of each set of chambers 110 have different chamber heights 112 from each other to provide a different thermal resistance for each chamber height 112 of reference medium.

Referring again to FIG. 3, in the example illustrated, the device 102 includes a pair of first and second thermal reservoirs 108a, 108b on opposite sides of the heater system 104, and a pair of first and second sets of chambers 110a, 110b arranged symmetrically on opposite sides of the heater system 104. Each set of chambers 110a, 110b is positioned between the heater system 104 and a respective thermal reservoir 108a, 108b (i.e. the first set of chambers 110a is positioned between the heater system 104 and the first thermal reservoir 108a, and the second set of chambers 110b is positioned between the heater system 104 and the second thermal reservoir 108b).

The first and second sets of chambers 110a, 110b define a plurality of symmetrical pairs 118 of the chambers 110. Each pair 118 of chambers includes one chamber from the first set of chambers 110a and a corresponding chamber from the second set of chambers 110b. The chambers in each pair 118 have the same chamber height 112 and are filled with the same medium. In the example illustrated, the pair of sample chambers 110s are filled with the sample medium and the remaining pairs of reference chambers 110r are filled with the reference medium. The chambers in each pair are in alignment with each other on opposite sides of a respective heater 106 for receiving heat energy from the same heater 106 through the inner end 114 of the chambers 110, while the outer end 116 of the chambers 110a, 110b is maintained at the common temperature. In the example illustrated, the outer end 116 of the first set of chambers 110a is maintained at the common temperature via the first thermal reservoir 108a, and the outer end 116 of the second set of chambers 110b is maintained at the same common temperature via the second thermal reservoir 108b.

In the example illustrated, the chamber height 112 of each chamber 110 can be on the microscale. In the example illustrated, the device 102 is shown to include five chambers 110 in each set of chambers (one sample chamber 110s and four reference chambers 110r). The chamber height 112 of the microchambers in each set can be, for example, 150, 300, 450, 600, and 750 μm, respectively, to provide corresponding thicknesses for the media layers when the chambers 110 are filled.

In the example illustrated, the device 102 further includes a parameter measurement system 120 configured to measure a parameter for each heater 106 to define a plurality of parameter values. Each parameter value corresponds to a temperature differential between a respective heater 106 and thermal reservoir 108 (and in turn, the thermal resistance through the respective chamber height of medium, and the temperature difference between the inner and outer ends of a respective chamber). As described in more detail below, the unknown thermal conductivity of the sample medium can then be determined based on the known thermal conductivity of the reference medium and a relationship between the plurality of parameter values relative to respective chamber heights of the sample and reference medium in the set(s) of chambers.

In the example illustrated, the plurality of heaters 106 comprise a plurality of resistive heaters connected in series to each other. In the example illustrated, the parameter measurement system 120 comprises a voltage measurement system 120 configured to measure voltage across each resistive heater to define a plurality of voltage values used for determining the unknown thermal conductivity. Each voltage value can define the inverse of the voltage measured for a respective heater 106. The voltage measurement system 120 can comprise, for example, a voltmeter system 123 coupled to each resistive heater 106 (e.g. through respective pairs of leads 122, one of which is shown schematically in FIG. 3).

In the example illustrated, the resistive heaters 106 have a generally identical resistance to each other for generating equal heat output under identical conditions. The heater system 104 is coupled to a power source for applying current through the plurality of resistive heaters 106 to generate the heat energy. The power source can be dedicated to the plurality of resistive heaters. In the example illustrated, the power source can operate on a constant voltage basis (though in some examples, the power source can function on constant current). The voltage of the power source can be preset, which can then drive a specific current through the resistive heaters, and the voltage of each resistance can then be measured.

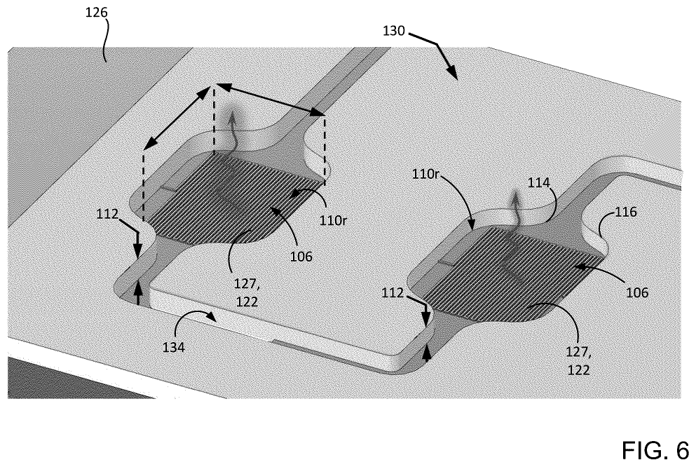

Referring to FIG. 6, in the example illustrated, each resistive heater 106 comprises a track 127 of conductive material (e.g. copper tracks). The tracks 122 can have a height and width on the microscale, and a length on the mm scale. For example, in some examples, each track can measure 18 μm in height, 60 μm in width, and 168 mm in length.

Referring to FIG. 3, in the example illustrated, each thermal reservoir 108 comprises a thermal block 126 in thermal communication with the outer end 116 of each chamber 110 in a respective set of chambers to maintain the outer end 116 of the chambers 110 at the common temperature. A respective thermoelectric module 128 (e.g. Peltier device) is coupled to each block 126 and is operable to maintain the block 126 at the reservoir temperature corresponding to (and in the example illustrated, equal to) the common temperature. In the example illustrated, integrated temperature sensors of one or both of the thermoelectric modules 128 serve as reservoir temperature sensor element(s) 124 for measuring the reservoir temperature. A voltage source can be provided to the thermoelectric modules for regulating the temperature of the thermal block 126. This voltage can be modifiable through, for example, a TEC controller, which can deliver either positive or negative voltage to the thermoelectric modules: a positive voltage to heat the thermal block, and a negative voltage to cool the thermal block.

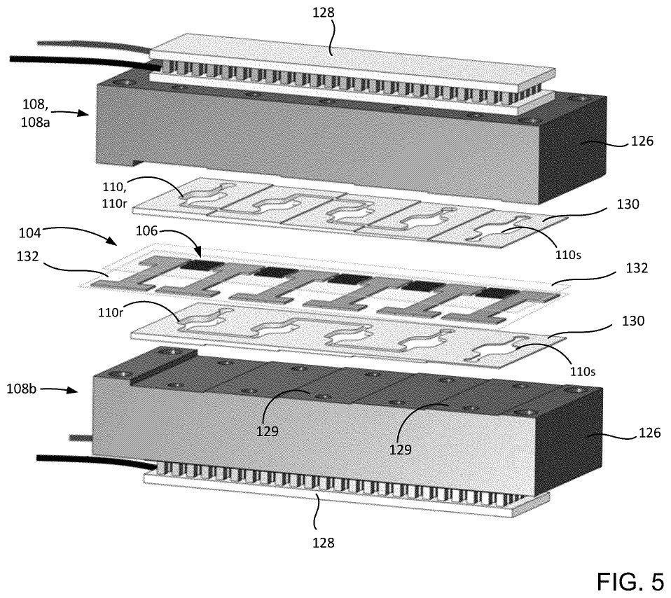

In the example illustrated, each block 126 is formed of a high thermal conductivity material (e.g. copper) and has a relatively high thermal mass (i.e. density×specific heat capacity) and thickness (e.g. 10 mm) relative to the media in the chambers 110. This can allow for the temperature of the thermal block to remain relatively stable, generally unaffected by the relatively minor heat generated by the heaters 106 for heating the relatively small volume of media in the chambers 110. In the example illustrated, the block 126 has a width and a length. In some examples, the width can be around 20 mm and the length can be around 60 mm. Referring to FIG. 5, in the example illustrated, each thermal block 126 has an inner side directed toward the heater system 104 and comprising a plurality of stepped surfaces 129 extending over respective chambers 110 and defining respective chamber heights 112 of the plurality of chambers 110.

Referring to FIG. 5, in the example illustrated, each set of chambers 110 is formed (e.g, etched) in a respective intermediate layer 130 of material positioned between the heater system 104 and the inner side of a respective thermal reservoir 108. In the example illustrated, the intermediate layer 130 comprises an insulating layer, which in the example illustrated, is formed of a relatively low thermal conductivity material (e.g. polydimethylsiloxane, polymethyl methacrylate, silicon mold, etc.). Referring to FIG. 6, this can help isolate and create a thermal barrier between the chambers 110 of each set in a lateral direction perpendicular to the chamber height 112, which can facilitate heat transfer through the medium in a one-dimensional path (i.e. along the chamber height 112). The chambers 110 in each set can also be positioned relatively close to each other in the lateral direction, which can help in maintaining the one-dimensional heat transfer by enhancing temperature uniformity in the lateral direction (e.g. horizontally in the example illustrated) relative to scenarios with wider channel spacing.

Referring to FIG. 5, in the example illustrated, each intermediate layer 130 has an inner surface facing the heater system 104 and an outer surface facing a respective thermal reservoir 108. In the example illustrated, the outer surface of each intermediate layer 130 has a plurality of stepped surfaces corresponding to and positioned against respective stepped surfaces 129 of the inner surface of a respective thermal block 126 to define the chamber heights 112. In the example illustrated, the outer end 116 of the chambers 110 in each set is open to the outer surface of a respective intermediate layer 130 for providing direct contact between the medium in the set of chambers 110 and the thermal reservoir 108 to facilitate heat transfer. Referring to FIG. 4, in the example illustrated, the thermal block 126 of the thermal reservoir is positioned over and covers the outer end 116 of the chambers 110 in a respective set to close the outer end 116.

The inner end 114 of each chamber 110 is in fluid isolation from its respective heater 106 by an electrically insulating substrate 132 to prevent direct/electrical contact between the media in the chambers 110 and the resistive heaters 106 (e.g. the copper tracks) and avoid potential short circuits. In the example illustrated, the resistive heaters 106 are positioned between and covered by a pair of insulating substrates 132 positioned on opposite sides of the heaters 106. The electrically insulating substrates 132 can be formed of, for example, polyimide. In the example illustrated, the insulating substrate 132 has a thickness 133 that is less than the chamber height 112 of each chamber 110. The insulating substrate 132 can be relatively thin, and can have a thickness 133 on the microscale (e.g. of around 50 μm). The material and thickness of the insulating substrate 132 is selected to permit heat transfer therethrough from the heaters 106 to the fluid at the inner end 114 of the chambers 110.

Referring to FIG. 5, in the example illustrated, each sample chamber 110s comprises a channel formed in the intermediate layer 130 and configured for flow-through of the sample fluid through the sample chamber 110 to help provide relatively fast, continuous, and/or autonomous measurement. In the example illustrated, in which the reference medium is fluid, the reference chambers 110r also comprise channels formed in the intermediate layer 130 and configured for flow-through of the reference fluid. In the example illustrated, each reference chamber 110r is in fluid communication with at least one reference inlet for filling the reference chamber 110r with reference fluid and at least one reference outlet for evacuating the reference fluid from the reference chamber 110r. The sample chambers 110s (FIG. 3) are in fluid isolation of the reference chambers 110r and in fluid communication with at least one sample inlet for filling the sample chambers 110s with sample fluid and at least one sample outlet for evacuating the sample fluid from the sample chambers 110s.

Referring to FIG. 6, in the example illustrated, the plurality of reference chambers 110r in each set of chambers 110 are in fluid communication with each other through conduits 134 extending between adjacent reference chambers 110r for filling and evacuating the plurality of reference chambers 110r in series. In the example illustrated, the reference chambers 110r and conduits 134 in each set of chambers are formed integrally (e.g, etched) in the intermediate layer 130. In the example illustrated, each chamber 110 has a width that is greater than that of the conduits 134 (e.g. at least three times greater). This can help provide a greater volume of fluid in the chambers through which the heat energy is conducted from the heater to the reservoir, relative to the amount of heat energy that may be conducted between laterally adjacent chambers through the relatively small volume of fluid in the conduits. In some examples, the width of each chamber is on the mm scale (e.g. around 4 mm), and each chamber can have a length in the direction of fluid flow (and perpendicular to the width) on the mm scale (e.g. of around 5 mm).

In other examples, the device can include reference inlets and outlets arranged for filling the plurality of reference chambers 110r of each set in parallel.

In other examples in which the reference medium is a solid, the reference chambers may be generally enclosed, and pre-filled with the reference solid.

Referring to FIG. 3, in the example illustrated, the device 102 includes a pump system 140 including at least one sample pump 144 in fluid communication with each sample chamber 110s and operable to pump sample fluid from a sample fluid reservoir to each sample chamber 110s to fill each sample chamber 110s with the sample fluid. In the example illustrated, the pump system 140 further includes at least one reference pump 142 in fluid communication with the reference chambers 110r and operable to pump reference fluid from a reference fluid reservoir to the reference chambers 110r to fill the reference chambers 110r with the reference fluid.

In the example illustrated, the thermal conductivity measurement system 100 further includes a control system 150 having at least one processor 152. The at least one processor 152 is configured to control operation of the device 102 to determine the unknown thermal conductivity of the sample medium. In the example illustrated, the unknown thermal conductivity of the sample medium is determined based on the known thermal conductivity of the reference fluid and a relationship of the plurality of parameters (e.g. voltages) measured via the parameter measurement system 120 relative to respective chamber heights of sample and reference media in the set of chambers (e.g. as described below with respect to the method 300).

In the example illustrated, the control system 150 is in communication with, and controls the operation of the system components, including, for example, the heater system 104, thermal reservoirs 108, voltage measurement system 120, pump system 140, etc. The control system 150 is operable to generate control signals for controlling operation of the heater system 104, thermoelectric modules 128, and/or pump system 140, and receive sensor signals from the voltage measurement system 120 for measurement of the voltage across each resistive heater 106. Components of the control system 150 (e.g. one or more processors 152) can be local, and/or include one or more remote components for controlling operation and/or processing data remotely (e.g. the processor 152 can comprise one or more local processing units and one or more remote processing units, each for performing respective control or processing operations for carrying out the present methods).

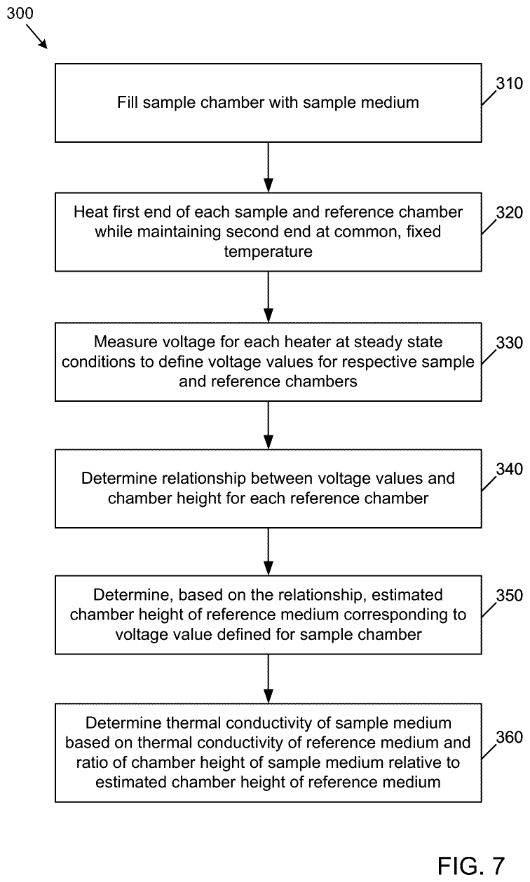

Referring to FIG. 7, an example method 300 of measuring thermal conductivity of fluids using the example device 102 is shown. The control system 150 can control the operation of the device 102 to perform the method 300, and/or one or more steps may be carried out and/or controlled by an operator.

At step 310 of the method 300, the sample and reference chambers 110s, 110r are filled with sample and reference media, respectively, to fill the chamber height 112 of each chamber 110 with respective media (e.g. through operation of the pump system 140). In some examples, the reference chambers 110r may be pre-filled with the reference medium (whether fluid or solid—e.g. during fabrication or during a previous measurement cycle), and so would not require filling at step 310.

At step 320, heat energy is supplied to the inner end 114 of each chamber 110 while maintaining the outer end 116 of each chamber 110 at the common temperature for conduction of heat through each chamber height 112 of sample/reference medium from the inner end 114 to the outer end 116. In the example illustrated, current is applied through the plurality of resistive heaters 106 of the heater system 104 to generate the heat energy for supply to the inner end 114 of each chamber 110. The outer end 116 of each chamber 110 is maintained at the common temperature through operation of the thermoelectric modules 128 to hold the thermal block 126 at the reservoir temperature during operation. The heat energy is supplied until steady state conditions are reached, which can be determined based on when the parameter (i.e. voltage in the example illustrated) measured at each heater 106 reaches steady state. In the example illustrated, at steady state conditions, the fluid in the chambers 110 and the insulating (e.g. polyimide) substrate 132 have a linear temperature profile, and the temperature profile in the thermal block 126 is generally uniform due to its high thermal conductivity (e.g. as shown in FIG. 1C).

At step 330, after steady state conditions are reached, voltage is measured across each heater 106 to define a plurality of voltage values. In the example illustrated, each voltage value defines the inverse of the measured voltage, which corresponds (inversely) to the temperature difference between a respective heater 116 and the thermal reservoir (and between the inner end of a respective chamber and the outer end of the chambers). In the example illustrated, the voltages are measured via the voltage measurement system 120.

At step 340, a functional relationship between the voltage values and the chamber heights for the plurality of reference chambers 110r is determined. In the example illustrated, the functional relationship is determined (e.g. by the processor 152) based on the plurality of voltage values (defining the inverse of the measured voltages) and the chamber height values for each chamber 110 or each pair of chambers 110 (e.g. stored in computer readable memory accessible by the processor 152). In the example illustrated, the functional relationship is linear, which can simplify evaluation of the unknown thermal conductivity.

At step 350, based on the functional relationship, an estimated chamber height of reference medium corresponding to the voltage value defined at step 330 for the sample chamber 110s is determined. In the example illustrated, the processor 152 can operate to determine the estimated chamber height based on the functional relationship (which in the example illustrated, defines a linear slope from which the estimated chamber height can be determined). Referring to FIG. 2B, the inverse of the measured voltages for the plurality of chambers 110 are shown relative to a linear slope defined by the functional relationship. The inverse of the measured voltages are proportional to the thickness of the medium in (and chamber height of) each chamber. When the chamber with a height of δ₁ is filled with the sample medium, the resulting inverse voltage is offset from what it would be if that chamber were filled with the reference medium. This offset in voltage for the sample medium corresponds to the voltage that would be generated by a reference medium with a height of δ*.

In some examples, the functional relationship may be non-linear, and adjustment coefficients may be determined and applied as necessary to compensate for the non-linearity.

At step 360, the unknown thermal conductivity is determined based on the known thermal conductivity and a ratio of the chamber height of the sample chamber relative to the estimated chamber height determined at step 350. In the example illustrated, the unknown thermal conductivity can be calculated by, for example:

$$k = ( \frac{{δ}_{1}}{{δ}^{*}} ) {k}_{ref}$$

where k is the unknown thermal conductivity coefficient, k_{ref} is the known thermal conductivity coefficient, δ₁ is the chamber height/fluid thickness of sample medium in the sample chamber and δ* is the estimated chamber height/medium thickness of reference medium determined at step 350.

After the thermal conductivity for an initial sample medium is determined, the sample chambers 110s can be evacuated of the initial sample medium and filled with a different sample medium (e.g. through operation of the pump system). The method can then be repeated to determine the thermal conductivity of the different sample medium.

Table 1, below, presents measured thermal conductivities for ten liquids and one gas using an example device like the device 102. Each test was repeated three times, and the standard deviation of the measurements is provided. The average absolute error of the measurements was found to be 1.1%, indicating good accuracy.

TABLE 1
Measured and literature values of thermal conductivity
of 10 liquids and gas at 30° C.

| | Compound | Measured | ±std | Literature | Error (%) |
|---|---|---|---|---|---|
| 1 | 1-Propanol | 0.1587 | 0.0013 | 0.1557 | 1.9 |
| 2 | Ethylene glycol | 0.2671 | 0.0047 | 0.2650 | 0.8 |
| 3 | Propylene glycol | 0.2125 | 0.0062 | 0.2153 | −1.3 |
| 4 | Ethanol | 0.1717 | 0.0007 | 0.1688 | 1.7 |
| 5 | Glycerol | 0.2846 | 0.0013 | 0.2847 | −0.0 |
| 6 | Ethyl laurate | 0.1387 | 0.0007 | 0.1358 | 2.1 |
| 7 | Hexyl Octanoate | 0.1482 | 0.0023 | 0.1493 | −0.7 |
| 8 | Acetone | 0.1591 | 0.0071 | 0.1575 | 1.0 |
| 9 | Dimethyl sulfoxide | 0.1874 | 0.0016 | 0.1853 | 1.1 |
| 10 | Water | 0.6109 | 0.0162 | 0.6132 | −0.4 |
| 11 | CO₂ | 0.01651 | 0.0002 | 0.01686 | −2.1 |

| | |
|---|---|
| Mean absolute error | 1.1% |

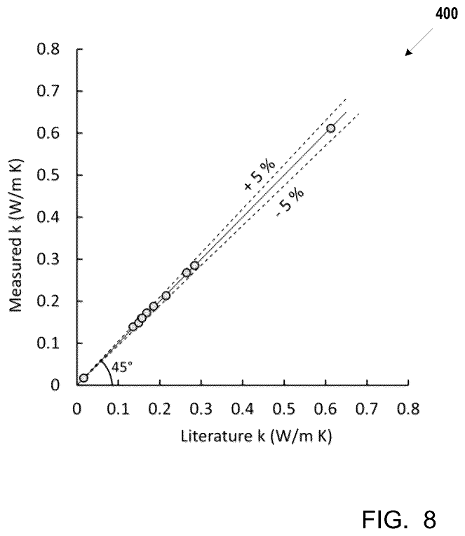

The results from Table 1 are visually represented in FIG. 8. Referring to FIG. 8, the graph 400 compares the measured thermal conductivities with literature values, and it is evident that the data align closely with the 45-degree line, indicating good accuracy. The dashed lines on the plot represent a ±5.0% error range, and all data points fall within this range, further confirming the relatively high level of accuracy achieved over a wide range of k.

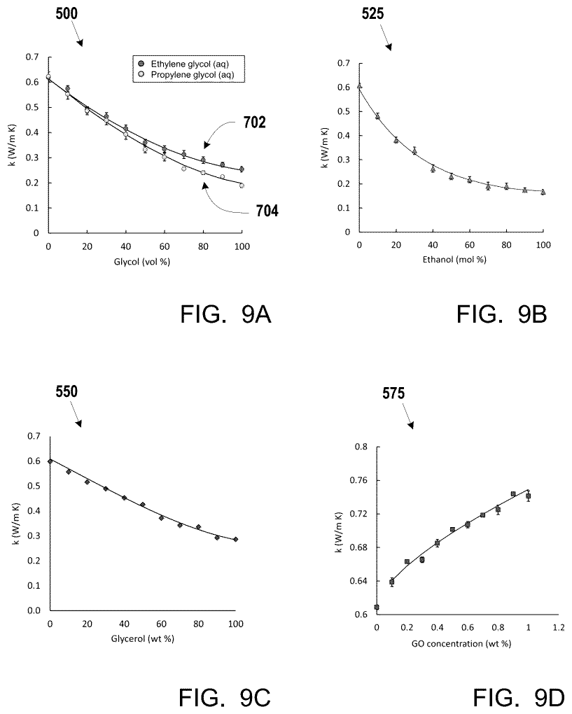

Reference is now made to FIGS. 9A-9C, which show the results of thermal conductivity measurements of fluid mixtures using an example device like that disclosed herein. Referring to FIG. 9A, the example graph 500 shows a curve 502 for the measured thermal conductivity of an ethylene glycol-water mixture and a curve 504 for the measured thermal conductivity of a propylene glycol-water mixture, versus increasing glycol by volume percent. Referring to FIG. 9B, the graph 525 shows a curve for the measured thermal conductivity of an ethanol-water mixture versus increasing ethanol by mole percent. Referring to FIG. 9C, the graph 550 shows a curve for the measured thermal conductivity of a glycerol-water mixture versus increasing glycerol by weight percent. As shown in FIGS. 9A-9C, the thermal conductivity of each mixture decreases with increasing liquid concentration due to water's higher thermal conductivity compared to the other liquids. These results closely follow the literature curve.

Referring to FIG. 9D, the graph 575 shows a curve for the measured thermal conductivity of a graphene oxide-water nanofluid versus increasing concentration of graphene oxide (0 to 1 weight percent). The measurements are consistent with the literature values for the nanofluid.

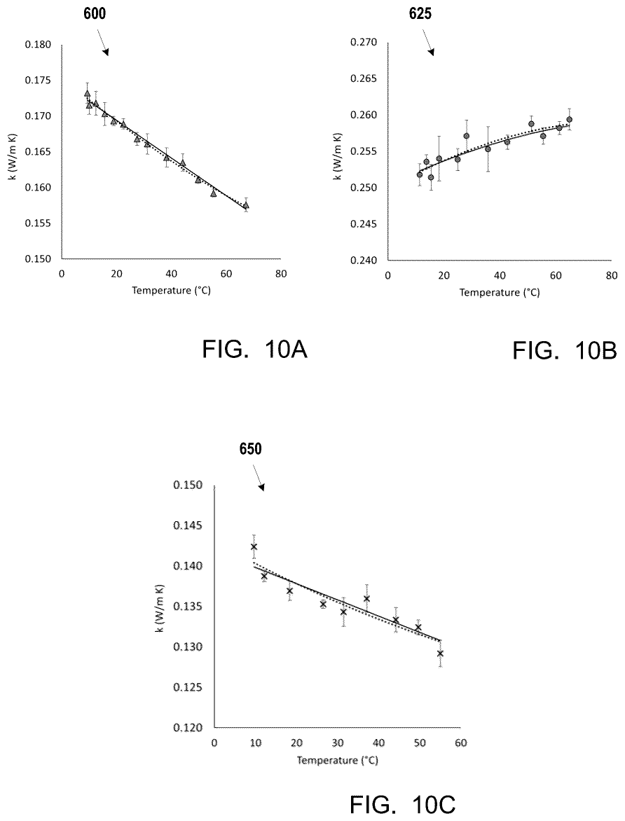

Reference is now made to FIGS. 10A-10C, which show the results of thermal conductivity measurements of liquids at different temperatures using an example device like that disclosed herein. FIGS. 10A-10C show quadratic polynomial fits in dashed lines, literature curves in solid lines, and error bar ranges. Referring to FIG. 10A, the graph 600 shows the measured thermal conductivity of ethanol versus increasing temperature. Referring to FIG. 10B, the graph 625 shows the measured thermal conductivity of ethylene glycol versus increasing temperature. Referring to FIG. 10C, the graph 650 shows the measured thermal conductivity of ethyl laurate versus increasing temperature. As shown in FIGS. 10A-10C, the measured thermal conductivities are satisfactorily accurate within the error bar ranges when measuring thermal conductivity versus temperature. The data in each graph matches closely with the literature curves, with a relative mean absolute error of 0.19% (graph 600), 0.12% (graph 625), and 0.28% (graph 650).

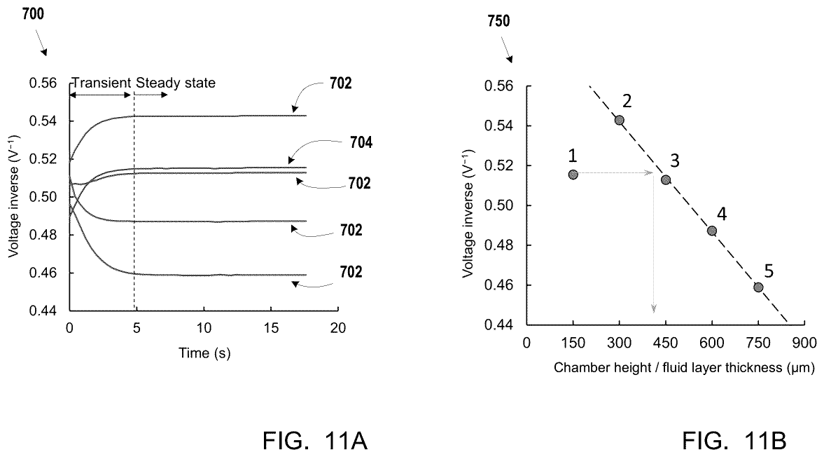

Reference is now made to FIGS. 11A-11B, which demonstrate the measurement speed of an example device as disclosed herein. FIG. 11A shows an example graph 700 illustrating the voltage response signal during a thermal conductivity measurement of propylene glycol at 30° C. The curves 702 represent the signals from chambers of different heights filled with water (reference fluid), while the curve 704 represents the signals from a chamber filled with propylene glycol (sample fluid). Notably, the signals stabilize to steady state conditions in approximately 5 seconds, a relatively faster response compared to some traditional steady-state k measurement methods (which can have an average response time of, for example, greater than 30 minutes) and comparable to transient methods known for their relatively high speed.

Referring to FIG. 11B, the graph 750 shows the steady-state values from the graph 700 plotted against the chamber height of each chamber. The inverse voltage for the chamber height of sample fluid is offset from the linear relationship established by the inverse voltage for the chamber heights of the reference fluid. The thermal conductivity of the sample fluid (propylene glycol) may be determined based on this offset using the approach described herein.

The devices, systems, and methods disclosed herein present a novel and efficient approach to measuring the thermal conductivity of various media. In some examples, the incorporation of microchambers, high and low thermal conductivity materials, and resistive heaters enables relatively precise and rapid measurements. Through extensive experimental testing, examples of the device described herein have demonstrated accurate measurements of thermal conductivity for liquids, mixtures, nanofluids, and gases over a wide range of thermal conductivities (0.017-0.75 Wm⁻¹K⁻¹) and temperatures (15-70° C.). The average absolute error of the measurements is found to be 1.1%, confirming the high accuracy.

The results presented herein showcase an example device's effectiveness in accurately determining thermal conductivity. The measured k closely aligns with literature values. Additionally, the example device's capability to measure the thermal conductivity of mixtures, such as ethanol-water, ethylene glycol-water, and nanofluids containing graphene oxide, further demonstrates its versatility.

Additionally, the measurement pace of some of the example devices can outperform some traditional steady-state methods, and in some cases delivering results three orders of magnitude swifter-just a few seconds versus approximately half an hour—while maintaining accuracy. This rapid turnaround not only matches the agility of transient methods known for their speed but also utilizes a notably smaller sample volume (˜10 μL).

In other examples, the thermal conductivity of the sample medium may be determined through a functional relationship based on measurement of other parameters, such as temperature at each heater (or inner end of each chamber), which corresponds to the temperature differential between respective heaters and the thermal reservoir (and in turn, the thermal resistance through the respective chamber), and is proportional to the thickness (chamber height) of media in the chambers:

$${T}_{H} - {T}_{0} = ( \frac{{R}_{0} {I}^{2}}{1 - α {R}_{0} {I}^{2}} ) ( \frac{δ}{2 k} + \frac{{δ}_{p}}{2 {k}_{p}} )$$

where R₀ is the resistance at T₀, I is current, α is the temperature coefficient of resistance, δₚ and kₚ are the thickness and thermal conductivity of the insulating substrate between the heaters and the fluid layers, respectively. In such examples, each resistive heater can be configured to serve both as a heater and a temperature sensor (e.g. resistance temperature detector (RTD)) for measuring temperature at the heater, or other temperature sensors may be used.

1. A method for measuring thermal conductivity of a sample medium having an unknown thermal conductivity, comprising:
a) filling a sample chamber of a set of chambers with the sample medium, the set of chambers further including a plurality of reference chambers filled with a reference medium having a known thermal conductivity, each chamber of the set of chambers having a chamber height of respective medium when filled, the chamber height extending from an inner end of the chamber to an outer end of the chamber opposite the inner end, and each reference chamber having a different chamber height of reference medium from each other reference chamber to provide a different thermal resistance through each chamber height of reference medium;
b) supplying heat energy to the inner end of each chamber while maintaining the outer end of each chamber at a common fixed temperature for conduction of heat through each chamber height of sample and reference media from the inner end to the outer end, the heat energy supplied by applying current through a plurality of resistive heaters, each resistive heater in thermal communication with the inner end of a respective chamber of the set of chambers;
c) during (b), measuring voltage across each resistive heater during steady state conditions to define a plurality of voltage values; and
d) determining the unknown thermal conductivity based on the known thermal conductivity of the reference medium and a relationship between the plurality of voltage values relative to respective chamber heights of the sample and reference media.

2. The method of claim 1, wherein (d) includes:
i) determining a functional relationship between the voltage values defined in (c) for the plurality of reference chambers and the chamber heights of reference medium in the plurality of reference chambers;
ii) determining, based on the functional relationship, an estimated chamber height of reference medium corresponding to the voltage value defined in (c) for the chamber height of sample medium in the sample chamber; and
iii) determining the unknown thermal conductivity based on the known thermal conductivity and a ratio of the chamber height of sample medium relative to the estimated chamber height of reference medium.

3. The method of claim 2, wherein the functional relationship is linear.

4. The method of claim 3, wherein the plurality of resistive heaters are connected in series and have a generally identical resistance to each other for generating equal heat output under identical conditions.

5. The method of claim 1, wherein each voltage value defines the inverse of the voltage measured in (c) for a respective heater.

6. The method of claim 1, wherein the outer end of each chamber is in thermal communication with a thermal reservoir held at a reservoir temperature for maintaining the outer end of each chamber at the constant temperature during (b).

7. The method of claim 6, wherein each thermal reservoir comprises a thermal block in thermal communication with the outer end of each chamber, and (c) includes operating a thermoelectric module coupled to the block to maintain the block at the reservoir temperature.

8. The method of claim 6, wherein the plurality of chambers are formed in an insulating layer positioned between the heater system and the thermal reservoir.

9. A device for measuring thermal conductivity of sample media, comprising:
a) a heater system including a plurality of resistive heaters operable to generate heat energy and a voltage measurement system configured to measure voltage across each resistive heater to define a plurality of voltage values;
b) at least one thermal reservoir maintainable at a fixed reservoir temperature;
c) at least one set of chambers, each set of chambers positioned between the heater system and a respective thermal reservoir, each chamber having a respective chamber height between an inner end of the chamber and an outer end of the chamber opposite the inner end, the inner end of each chamber in thermal communication with a respective resistive heater of the heater system for receiving heat energy from the respective heater, and the outer end of each chamber in thermal communication with the respective thermal reservoir for maintaining the outer end of each chamber at a common temperature corresponding to the reservoir temperature;
d) each set of chambers including at least one sample chamber for filling with a sample medium having an unknown thermal conductivity and a plurality of reference chambers for containing a reference medium having a known thermal conductivity, the plurality of reference chambers of each set of chambers having different chamber heights from each other for providing a different thermal resistance through each chamber height of reference medium, and for determining the unknown thermal conductivity based on the known thermal conductivity of the reference medium and a relationship between the plurality of voltage values relative to respective chamber heights of the sample and reference medium.

10. The device of claim 9, wherein the plurality of resistive heaters are connected in series to each other.

11. The device of claim 10, wherein the resistive heaters have a generally identical resistance to each other for generating equal heat output under identical conditions.

12. The device of claim 9, wherein each thermal reservoir comprises a thermal block in thermal communication with the outer end of a respective set of chambers and a thermoelectric module coupled to the block and operable to maintain the block at the reservoir temperature.

13. The device of claim 9, wherein each set of chambers is formed in an intermediate layer of material positioned between the heater system and the respective thermal reservoir.

14. The device of claim 13, wherein the sample chamber comprises a microchannel formed in the intermediate layer and configured for flow-through of sample medium through the sample chamber to facilitate filling and evacuation of the sample chamber.

15. The device of claim 13, wherein the material of the intermediate layer has a relatively low thermal conductivity to thermally isolate the set of chambers from each other in a lateral direction perpendicular to the chamber height for facilitating one-dimensional heat transfer along the chamber height.

16. The device of claim 9, wherein the outer end of the chambers in each set is closed by the respective thermal reservoir.

17. The device of claim 9, wherein the inner end of each chamber is electrically insulated from the respective heater by an insulating substrate positioned between the inner end and the respective heater.

18. The device of claim 9, wherein the at least one thermal reservoir includes a pair of thermal reservoirs on opposite sides of the heater system, and the at least one set of chambers includes a pair of sets of the chambers arranged symmetrically on opposite sides of the heater system between the heater system and respective thermal reservoirs, the pair of sets of chambers defining a plurality of symmetrical pairs of the chambers, the chambers in each pair having a same chamber height, filled with a same medium, and in alignment with each other on opposite sides of a respective heater for receiving heat energy from the respective heater through the inner end of the chambers while the outer end of the chambers is maintained at the common temperature.

19. The device of claim 9, further comprising a control system configured to: (i) energize the thermal reservoir to maintain the outer end of the chambers at a common, fixed temperature; and (ii) energize the plurality of heaters to supply heat energy to the inner end of respective chambers for conduction through each chamber height of medium to the thermal reservoir, and the control system including at least one processor configured to determine the unknown thermal conductivity based on the known thermal conductivity of the reference medium and a relationship between the plurality of voltage values relative to respective chamber heights of the sample and reference medium.

20. A method for measuring thermal conductivity of a sample medium having an unknown thermal conductivity, comprising:
a) filling a sample chamber of a set of chambers with the sample medium, the set of chambers further including a plurality of reference chambers filled with a reference medium having a known thermal conductivity, each chamber of the set of chambers having a chamber height of respective medium when filled, the chamber height extending from an inner end of the chamber to an outer end of the chamber opposite the inner end, and each reference chamber having a different chamber height of reference medium from each other reference chamber to provide a different thermal resistance through each chamber height of reference medium;
b) supplying heat energy to the inner end of each chamber while maintaining the outer end of each chamber at a common fixed temperature for conduction of heat through each chamber height of sample and reference media from the inner end to the outer end;
c) during (b), measuring a parameter for each heater during steady state conditions to define a plurality of parameter values, each parameter value corresponding to a temperature differential between the inner end and the outer end of a respective chamber; and
d) determining the unknown thermal conductivity based on the known thermal conductivity of the reference medium and a relationship between the plurality of parameter values relative to respective chamber heights of the sample and reference media.
